(19) United States
(12) Patent Application Publication
(10) Pub. No.: US 2005/0021856 A1
(43) Pub. Date: Jan. 27, 2005

(54) Methods and systems for updating address information

(75) Inventors: Paul P. Basile, Alexandria, VA (US); Christopher M. Taddei, Alexandria, VA (US)

Correspondence Address: Finnegan, Henderson, Farabow,;Garrett & Dunner, L.L.P., 1300 I Street, N.W., Washington, DC, 20005-3315, US

(73) Assignee: United States Postal Service

(21) Appl. No.: 10/833,070

(22) Filed: Apr. 28, 2004

Related U.S. Application Data
(60) Provisional application No. 60/467,244, filed on Apr. 30, 2003.

(51) Int. Cl. G06F 15/16

(52) U.S. Cl. 709/245

(57) ABSTRACT

Systems and methods for updating address information may comprise receiving change-of-address data, the change-of-address data comprising at least old address information and new address information. Next, the systems and methods may include saving the change-of-address data in a first change-of-address database and transmitting the change-of-address data to an item processing center corresponding to the old address information. Moreover, the systems and methods may comprise transmitting the change-of-address data from the first change-of-address database to a central mark-up unit and determining if the change-of-address data needs correction at the central mark-up unit. Furthermore, the systems and methods may include correcting the change-of-address data if it was determined at the central mark-up unit that the change-of-address data needs correction and transmitting the change-of-address data from the central mark-up unit to a central change-of-address database. Also, the systems and methods may include transmitting the change-of-address data from the central mark-up unit to the item processing center corresponding to the old address information if it was determined at the central mark-up unit that the change-of-address data needs correction.

### RELATED APPLICATION

Under provisions of 35 U.S.C. § 119(e), this Application claims the benefit of U.S. Provisional Application No. 60/467,244, filed Apr. 30, 2003, which is incorporated herein by reference.

### BACKGROUND

I. Technical Field

The present invention generally relates to updating address information. More particularly, the present invention relates to updating address information used in an item delivery system.

II. Background Information

The United States Postal Service (USPS) is an independent government agency that provides mail delivery and other services to the public. The USPS is widely recognized as a safe and reliable means for sending and receiving mail and other items. With the advent and steady growth of electronic mail and electronic commerce, the physical mail stream will increasingly be utilized for sending and receiving packages and other items.

The USPS processes and delivers billions of items each year. In this large-scale item delivery system, the burden associated with maintaining current address information is significant. For example, in fiscal year, 2001, the USPS processed 43.6 million change-of-address (COA) requests from its commercial and residential recipients, at a cost of nearly $194 million ($4.43 per request submitted). In addition to being costly, this predominantly manual process can also be time-consuming. For example, the standard USPS statement for COA processing time is that a recipient should begin to receive forwarded items within 7 to 10 days from a COA request's effective date.

Moreover, because addresses may not be standardized or validated until they are sent to a central markup unit (CMU) from the recipient's former post office, the potential for additional delays due to bad addresses (old or new) may be high. Actual cycle time may range from 3 to 13 days. The USPS currently estimates, for example, that it spends approximately $1.9 billion annually on undeliverable-as-addressed (UAA) mail, part of this cost being due to lack of address validation.

To help improve the COA process, the USPS has established an Internet COA (ICOA) option that allows recipients to make a COA over the Internet, for example. Recipients are charged for credit card processing that may be required in order to validate the customer's identity. The new address may be validated, for example, using delivery point verification (DPV) technology. An ICOA host database, resident at the USPS's national customer service center (NCSC) in Memphis, Tenn., downloads ICOA information daily to local CMUs. At local CMUs, ICOA information is reviewed and saved. ICOA information is printed, sorted and dispatched to the recipient's former post office. The saved ICOA information is uploaded to the NCOA database once daily and an operator at the former post office records and files the ICOA information. The cycle time on ICOA information ranges from 1 to 6 days after e-mail confirmation is received, and costs the USPS approximately $1.02 on average, resulting in approximately a 77% reduction in cost versus paper request forms. However, in fiscal year, 2003, ICOAs represented only about 3% of all COA records processed that year. The required credit card use over the Internet to confirm identity may suppress the use of ICOA use.

Great inefficiencies are created in conventional COA processes because, for example, paper COAs are costly and time consuming and ICOAs represent only a small portion of all COAs processed each year. Accordingly, providing updated address information remains an elusive goal. Thus, there remains a need for efficiently providing updated address information. In addition, there remains a need for efficiently providing updated address information using a system more acceptable to item delivery system recipients.

### SUMMARY

Consistent with embodiments of the present invention, systems and methods are disclosed for updating address information.

In accordance with one embodiment, a method for updating address information comprises receiving change-of-address data, the change-of-address data comprising at least old address information and new address information, saving the change-of-address data in a first change-of-address database, transmitting the change-of-address data to an item processing center corresponding to the old address information, transmitting the change-of-address data from the first change-of-address database to a central mark-up unit, determining if the change-of-address data needs correction at the central mark-up unit, correcting the change-of-address data if it was determined at the central mark-up unit that the change-of-address data needs correction, transmitting the change-of-address data from the central mark-up unit to a central change-of-address database, and transmitting the change-of-address data from the central mark-up unit to the item processing center corresponding to the old address information if it was determined at the central mark-up unit that the change-of-address data needs correction.

In accordance with another embodiment, a system for updating address information comprises a change of address service front-end further comprising, a component for receiving change-of-address data, the change-of-address data comprising at least old address information and new address information, a component for saving the change-of-address data in a first change-of-address database, a component for transmitting the change-of-address data to an item processing center corresponding to the old address information, and a component for transmitting the change-of-address data from the first change-of-address database to a central mark-up unit; the central mark-up unit comprising, a component for determining if the change-of-address data needs correction at the central mark-up unit, a component for correcting the change-of-address data if it was determined at the central mark-up unit that the change-of-address data needs correction, a component for transmitting the change-of-address data from the central mark-up unit to a central change-of-address database, and a component for transmitting the change-of-address data from the central mark-up unit to the item processing center corresponding to the old address information if it was determined at the central mark-up unit that the change-of-address data needs correction.

In accordance with yet another embodiment, a computer-readable medium which stores a set of instructions which when executed performs a method for updating address information, the method executed by the set of instructions comprising receiving change-of-address data, the change-of-address data comprising at least old address information and new address information, saving the change-of-address data in a first change-of-address database, transmitting the change-of-address data to an item processing center corresponding to the old address information, and transmitting the change-of-address data from the first change-of-address database to a central mark-up unit.

In accordance with yet another embodiment, a computer-readable medium which stores a set of instructions which when executed performs a method for updating address information, the method executed by the set of instructions comprising determining if the change-of-address data needs correction at the central mark-up unit, correcting the change-of-address data if it was determined at the central mark-up unit that the change-of-address data needs correction, transmitting the change-of-address data from the central mark-up unit to a central change-of-address database, and transmitting the change-of-address data from the central mark-up unit to the item processing center corresponding to the old address information if it was determined at the central mark-up unit that the change-of-address data needs correction.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of a prior art system for updating address information;

FIG. 2 is a block diagram of another prior art system for updating address information;

FIG. 3 is a block diagram of an exemplary system for updating address information consistent with an embodiment of the present invention; and

FIG. 4 is a flow chart of an exemplary method for updating address information consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

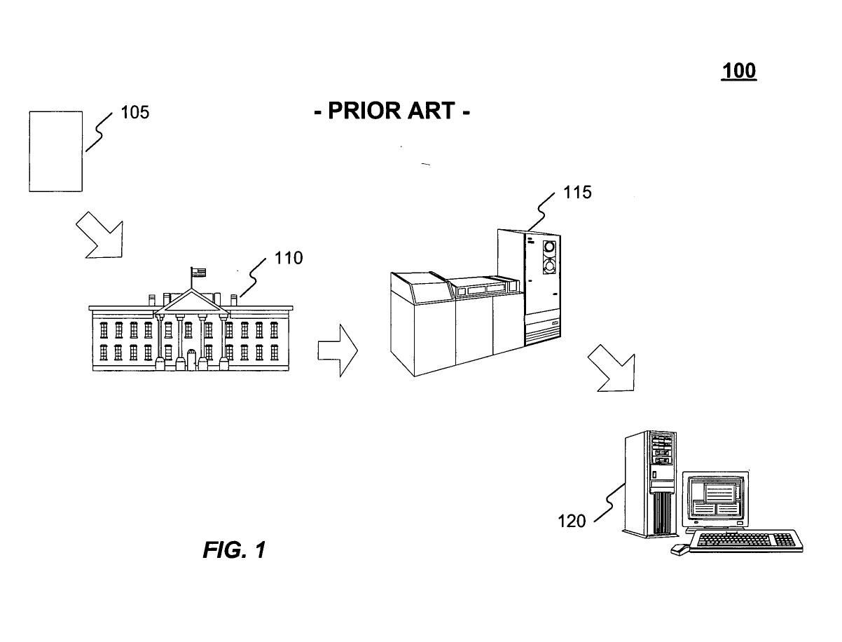

FIG. 1 illustrates a conventional walk-in/mail-in address updating system 100. For example, when a recipient moves from a first address to a second address, the recipient may inform a delivery system operator, such as the USPS, of this move. From the information regarding the move, the delivery system operator may forward items, originally directed toward the old address, to the new address. According to system 100, a recipient may complete a COA form 105 and then submit it either by bringing it to an item processing center 110 (a local post office, for example) or by mailing it to item processing center 110. Item processing center 110 may review the completed COA form 105, which may take as much as 2 days, for example. COA form 105 may then be further processed by a CMU 115. At CMU 115, the information contained in COA form 105 may be inputted into an electronic form and then may be downloaded, for example, to a national change of address database (NCOA) 120 once daily. When the delivery system operator comprises the USPS, the aforementioned further processing by CMU 115 may include: i) sorting COA forms and preparing them for manual input to a computerized forwarding information system (CFIS) (not shown); ii) affixing yellow labels to each COA form; and iii) sorting and dispatching the COA forms with yellow labels to former post offices where an operator may record and file the COA forms. A former post office, for example, may comprise a post office corresponding to the recipient's old address.

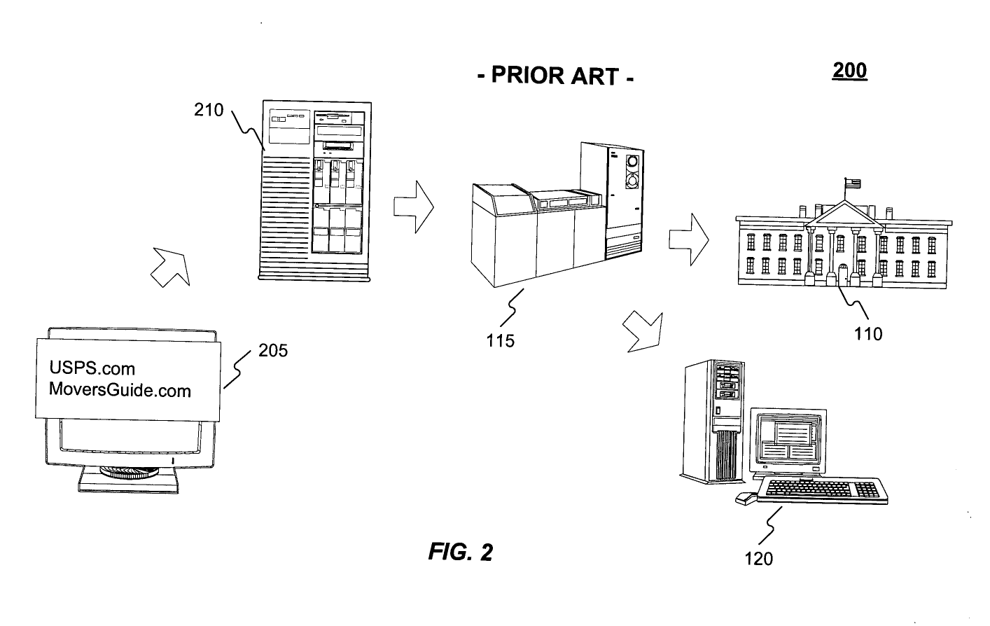

FIG. 2 illustrates a conventional Internet updating system 200. According to system 200, a recipient may provide ICOA information to a delivery operator system-maintained Internet web-site 205 where the ICOA information may, in real time, be saved in a ICOA database 210. While entering the ICOA information, the recipient may acknowledge a privacy statement on the web site. Moreover, the recipient's identity may be checked through credit card validation and valid email address submission. The recipient may be charged for credit card processing associated with the validation. Furthermore, the recipient may be required to return e-mail confirmation before the ICOA information is ever transmitted from database 210.

From database 210, the ICOA information may then be downloaded to CMU 115, once a day, for example. The ICOA information may be further processed by CMU 115, and then downloaded to NCOA 120, once a day, for example. A copy of the ICOA information may also be provided to item processing center 110, for example, the recipient's former local post office, at least within two days. At CMU 115, the ICOA information may be downloaded to a client server application. Moreover, the ICOA information may be reviewed, corrected or deleted, and saved. If item processing center 110, comprises a local post office, for example, the ICOA information may be printed and a yellow label affixed. The printed record may be sorted and dispatched to the recipient's former local post office, for example.

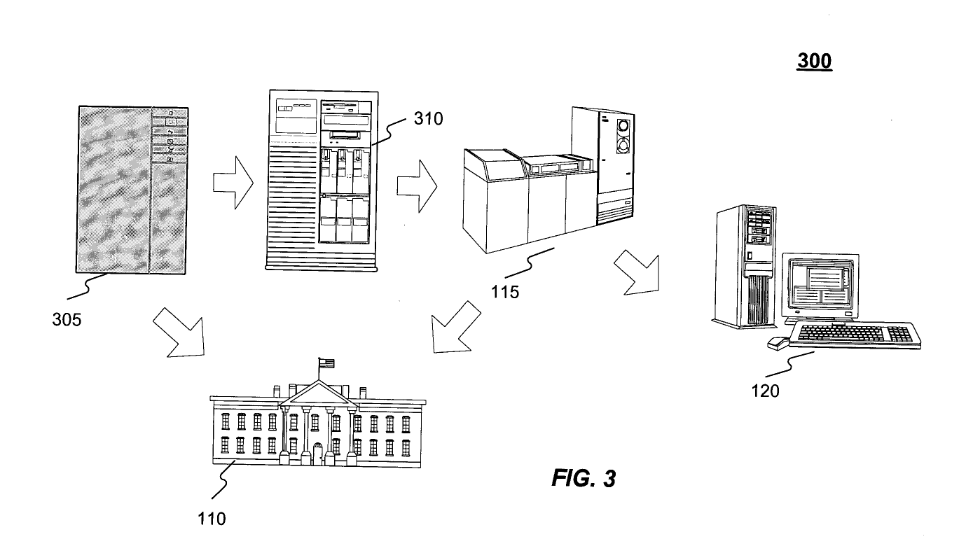

Systems and methods consistent with embodiments of the present invention update address information for item recipients within an item delivery system. FIG. 3 illustrates an address updating system 300. System 300 may be used by itself or in conjunction with system 100, system 200, or both. According to system 300, a recipient may call a telephone number through a publicly switched telephone network (PSTN) (not shown), for example, for a delivery system-maintained (or affiliated) telephone COA service. This service may comprise, or otherwise utilize, a COA service front-end 305, which may in turn use an interactive voice response system (IVR). An IVR is an automated telephone answering system that may respond with a voice menu and may allow the IVR user to make choices and enter information via a telephone keypad. IVR systems are widely used in call centers as well as a replacement for human switchboard operators. The telephone number may be toll free, though a toll number may also be provided.

A recipient, wishing to change their address, may contact the delivery system operator via the aforementioned telephone number. After being connected with the IVR in front-end 305, the recipient may be led through a variety of prompts over the telephone before entering COA data. The COA data may comprise old address information and new address information. Furthermore, the COA data may be electronically validated. The prompts may include a request for acknowledgement of a privacy statement and a credit card validation for identity check. Specifically, the privacy statement acknowledgement may be collected via the IVR, the recipient's identity may be checked through credit card validation, and the recipient's call automated number identification (ANI) may be stored. Once the new address is validated, system 300 may simultaneously transmit the validated COA data to both a first COA database 310 and item processing center 110 in real time. The aforementioned validated COA data may be referred to as telephone COA (TCOA) information. Database 310 may be included in front-end 305. Also, first COA database 310 may comprise ICOA database 210.

Once in database 310, the TCOA information may be downloaded to CMU 115 daily, and may then be handled much like the ICOA information as described above with respect to FIG. 2. After item processing center 110 receives the TCOA information, the TCOA information may then be entered on an appropriate form and filed. If additional changes are made to the TCOA information at CMU 115, CMU 115 may dispatch a hard copy of the correct information to item processing center 110.

Furthermore, while an IVR may be used in system 300, some recipients may require a live customer service representative's (CSR) assistance. In such instances, a CSR may perform some or all of the tasks otherwise performed by the IVR. Regarding costs, for example, address updates using IVR-only information may cost the USPS $1.27 per update, while CSR-assisted information may cost $2.82 per update. Accordingly, a savings of 37% to 71% over walk-in/mail-in COA information (system 100, for example) may be provided. Further, the TCOA information may not face the same credit card obstacles as ICOA information (system 200, for example), as most recipients may be comfortable with providing credit card information over the phone rather than the Internet.

An embodiment consistent with the invention may comprise a system for updating address information. The system may comprise a change-of-address service front-end and a central mark-up unit. The change-of-address service front-end may comprise: i) a component for receiving change-of-address data; ii) a component for saving the change-of-address data; iii) a component for transmitting the change-of-address data to an item processing center corresponding to the old address information; and iv) a component for transmitting the change-of-address data from the first change-of-address database to a central mark-up unit. Each of the aforementioned components may comprise or otherwise be utilized within front-end 305, as described above with respect to FIG. 3.

The central mark-up unit may comprise: i) a component for determining if the change-of-address data needs correction at the central mark-up unit; ii) a component for correcting the change-of-address data; iii) a component for transmitting the change-of-address data from the central mark-up unit to a central change-of-address database; and iv) a component for transmitting the change-of-address data from the central mark-up unit to the item processing center corresponding to the old address information. Each of the aforementioned components may comprise or otherwise be utilized within CMU 115, as described above with respect to FIG. 3.

Consistent with an embodiment of the present invention, the aforementioned system for updating address information and its exemplary components may comprise any suitable combination of hardware, software, and/or firmware. Furthermore, the invention may be practiced using electrical circuits comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within or may otherwise utilize a general purpose computer or in any other circuits or systems.

Moreover, components included in system 300 may be implemented using a personal computer, network computer, mainframe, or other similar microcomputer-based workstation. The components may though comprise any type of computer operating environment, such as hand-held devices, multiprocessor systems, microprocessor-based or programmable sender electronic devices, minicomputers, mainframe computers, and the like. The components may also be practiced in distributed computing environments where tasks are performed by remote processing devices. Furthermore, any of the components may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the components may comprise other systems or devices.

Furthermore, the aforementioned components may communicate using a network. The network may comprise, for example, a local area network (LAN) or a wide area network (WAN). Such networking environments are commonplace in offices, enterprise-wide computer networks, intranets, and the Internet. When a LAN is used as the network, a network interface located at any of the processors may be used to interconnect any of the processors. When the network is implemented in a WAN networking environment, such as the Internet, the componets may typically include an internal or external modem (not shown) or other means for establishing communications over the WAN. Further, in utilizing the network, data sent over the network may be encrypted to insure data security by using known encryption/decryption techniques.

In addition to utilizing a wire line communications system as the network, a wireless communications system, or a combination of wire line and wireless may be utilized as the network in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The components in the wireless environment can be any mobile terminal, such as the mobile terminals described above. Wireless data may include, but is not limited to, paging, text messaging, e-mail, Internet access and other specialized data applications specifically excluding or including voice transmission.

System 300 may also transmit data by methods and processes other than, or in combination with, the network. These methods and processes may include, but are not limited to, transferring data via, diskette, CD ROM, facsimile, conventional mail, an interactive voice response system (IVR), or via voice over a publicly switched telephone network.

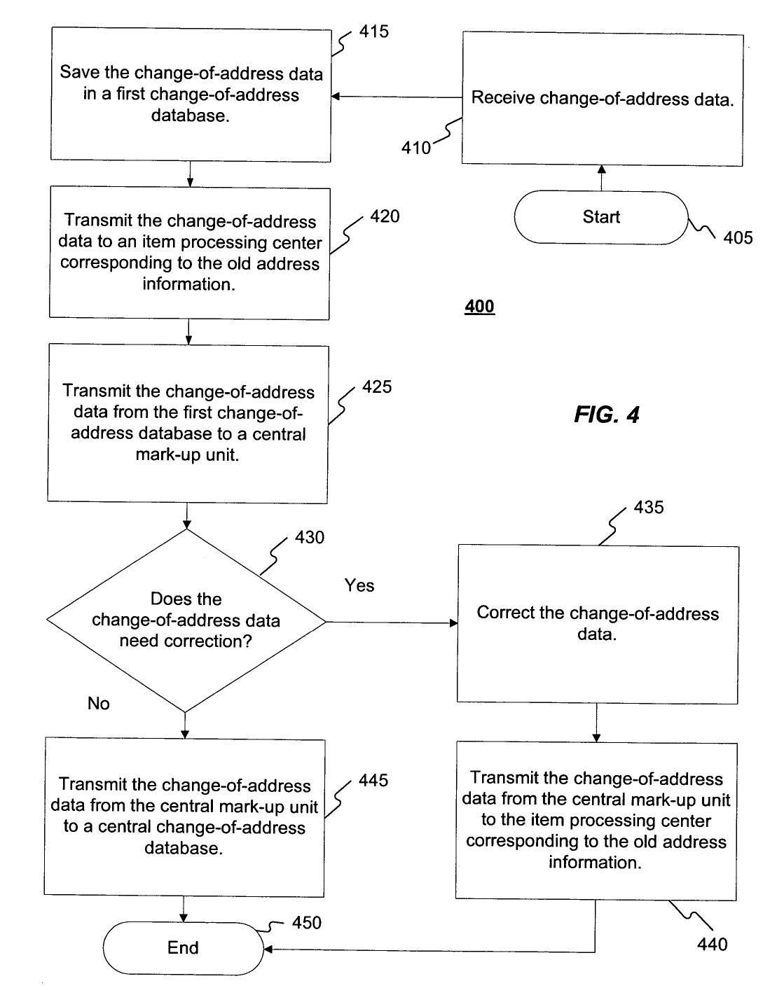

FIG. 4 is a flow chart setting forth the general stages involved in an exemplary method 400 consistent with the invention for updating address information using, for example, system 300 of FIG. 3. Exemplary ways to implement the stages of exemplary method 400 will be described in greater detail below. Exemplary method 400 may begin at starting block 405 and proceed to stage 410 where system 300 may receive COA data. For example, COA data may be received at front-end 305 from a recipient wishing to notify the delivery system operator of a COA. The recipient may connect with an IVR in front-end 305 enter the COA data through the IVR over a PSTN.

From stage 410, where system 300 receives the COA data, exemplary method 400 may advance to stage 415 where system 300 may save the COA data in a first change-of-address database. For example, the COA data may be sent from front-end 305 over the network and saved in database 310.

Once system 300 saves the COA data in the first COA database in stage 415, exemplary method 400 may continue to stage 420 where system 300 may transmit the COA data to an item processing center corresponding to the old address information. For example, front-end 305 may transmit the COA data over the network to item processing center 110.

After system 300 transmits the COA data to the item processing center corresponding to the old address information in stage 420, exemplary method 400 may proceed to stage 425 where system 300 may transmit the COA data from the first COA database to a central mark-up unit. For example, front-end 305 may transmit the COA data over the network to CMU 115.

From stage 425, where system 300 transmits the COA data from the first COA database to the central mark-up unit, exemplary method 400 may advance to decision block 430 where system 300 may determine if the COA data needs correction. For example, CMU 115 may determine if the old address information or the new address information corresponds to an actual delivery point in the item delivery system.

From decision block 430, if it system 300 determined that the COA data needs correction, exemplary method 400 may advance to stage 435 where system 300 may correct the COA data. For example, at CMU 115, the COA data may be downloaded to a client server application. Moreover, the COA data may be reviewed, corrected or deleted, and saved.

Once system 300 corrects the COA data in stage 435, exemplary method 400 may continue to stage 440 where system 300 may transmit the COA data from the central mark-up unit to the item processing center corresponding to the old address information. For example, once corrected, CMU 115 may transmit the COA data over the network to item processing center 110.

From decision block 430, however, if system 300 determined that the COA data does not need correction, exemplary method 400 may advance to stage 445 where system 300 may transmit the COA data from the central mark-up unit to a central COA database. For example, CMU 115 may transmit the COA data over the network to NCOA 120.

Once system 300 transmits the COA data from the central mark-up unit to a central COA database in stage 445, or once system 300 transmits the COA data from the central mark-up unit to the item processing center corresponding to the old address information in stage 440, exemplary method 400 may end at stage 450.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

1. A method for updating address information, comprising:
receiving change-of-address data, the change-of-address data comprising at least old address information and new address information;
saving the change-of-address data in a first change-of-address database;
transmitting the change-of-address data to an item processing center corresponding to the old address information;
transmitting the change-of-address data from the first change-of-address database to a central mark-up unit;
determining if the change-of-address data needs correction at the central mark-up unit;
correcting the change-of-address data if it was determined at the central mark-up unit that the change-of-address data needs correction;
transmitting the change-of-address data from the central mark-up unit to a central change-of-address database; and
transmitting the change-of-address data from the central mark-up unit to the item processing center corresponding to the old address information if it was determined at the central mark-up unit that the change-of-address data needs correction.

2. The method of claim 1, wherein receiving the change-of-address data further comprises using an interactive voice response system (IVR).

3. The method of claim 1, wherein receiving the change-of-address data further comprises using an interactive voice response system (IVR) in conjunction with a customer service representative.

4. The method of claim 1, wherein receiving the change-of-address data further comprises performing an identity check on a person providing the change-of-address data.

5. The method of claim 4, wherein the identity check further comprises using a credit card to determine the identity of the person.

6. The method of claim 1, wherein receiving the change-of-address data further comprises validating the change-of-address data.

7. The method of claim 1, wherein validating the change-of-address data comprises determining if at least one of the old address information and the new address information correspond to a format used in an item delivery system corresponding to the change-of-address data.

8. The method of claim 1, wherein the item processing center corresponding to the old address information comprises a United States Post Office that services an address corresponding to the old address information.

9. The method of claim 1, wherein determining if the change-of-address data needs correction comprises determining if at least one of the old address information and the new address information correspond to an actual delivery point in an item delivery system.

10. The method of claim 1, wherein the first change-of-address database is configured to receive other change-of-address data via an Internet application.

11. A system for updating address information, the system comprising:
a change of address service front-end comprising:
a component for receiving change-of-address data, the change-of-address data comprising at least old address information and new address information;
a component for saving the change-of-address data in a first change-of-address database;
a component for transmitting the change-of-address data to an item processing center corresponding to the old address information; and
a component for transmitting the change-of-address data from the first change-of-address database to a central mark-up unit; the central mark-up unit comprising:
a component for determining if the change-of-address data needs correction at the central mark-up unit;
a component for correcting the change-of-address data if it was determined at the central mark-up unit that the change-of-address data needs correction;
a component for transmitting the change-of-address data from the central mark-up unit to a central change-of-address database; and
a component for transmitting the change-of-address data from the central mark-up unit to the item processing center corresponding to the old address information if it was determined at the central mark-up unit that the change-of-address data needs correction.

12. The system of claim 11, wherein the component for receiving the change-of-address data is further configured for using an interactive voice response system (IVR).

13. The system of claim 11, wherein the component for receiving the change-of-address data is further configured for using an interactive voice response system (IVR) in conjunction with a customer service representative.

14. The system of claim 12, wherein the component for receiving the change-of-address data is further configured for performing an identity check on a person providing the change-of-address data.

15. The system of claim 14, wherein the identity check further comprises using a credit card to determine the identity of the person.

16. The system of claim 11, wherein the component for receiving the change-of-address data is further configured for validating the change-of-address data.

17. The system of claim 11, wherein validating the change-of-address data comprises determining if at least one of the old address information and the new address information correspond to a format used in an item delivery system corresponding to the change-of-address data.

18. The system of claim 11, wherein the item processing center corresponding to the old address information comprises a United States Post Office that services an address corresponding to the old address information.

19. The system of claim 11, wherein the component for determining if the change-of-address data needs correction is further configured for determining if at least one of the old address information and the new address information correspond to an actual delivery point in an item delivery system.

20. The system of claim 11, wherein the first change-of-address database is configured to receive other change-of-address data via an Internet application.

21. A computer-readable medium which stores a set of instructions which when executed performs a method for updating address information, the method executed by the set of instructions comprising:
receiving change-of-address data, the change-of-address data comprising at least old address information and new address information;
saving the change-of-address data in a first change-of-address database;
transmitting the change-of-address data to an item processing center corresponding to the old address information; and
transmitting the change-of-address data from the first change-of-address database to a central mark-up unit.

22. The computer-readable medium of claim 21, wherein receiving the change-of-address data further comprises using an interactive voice response system (IVR).

23. The computer-readable medium of claim 21, wherein receiving the change-of-address data further comprises using an interactive voice response system (IVR) in conjunction with a customer service representative.

24. The computer-readable medium of claim 21, wherein receiving the change-of-address data further comprises performing an identity check on a person providing the change-of-address data.

25. The computer-readable medium of claim 24, wherein the identity check further comprises using a credit card to determine the identity of the person.

26. The computer-readable medium of claim 21, wherein receiving the change-of-address data further comprises validating the change-of-address data.

27. The computer-readable medium of claim 21, wherein validating the change-of-address data comprises determining if at least one of the old address information and the new address information correspond to a format used in an item delivery system corresponding to the change-of-address data.

28. The computer-readable medium of claim 21, wherein the item processing center corresponding to the old address information comprises a United States Post Office that services an address corresponding to the old address information.

29. The computer-readable medium of claim 21, wherein the first change-of-address database is configured to receive other change-of-address data via an Internet application.

30. A computer-readable medium which stores a set of instructions which when executed performs a method for updating address information, the method executed by the set of instructions comprising:
determining if the change-of-address data needs correction at the central mark-up unit;
correcting the change-of-address data if it was determined at the central mark-up unit that the change-of-address data needs correction;
transmitting the change-of-address data from the central mark-up unit to a central change-of-address database; and
transmitting the change-of-address data from the central mark-up unit to the item processing center corresponding to the old address information if it was determined at the central mark-up unit that the change-of-address data needs correction.

31. The computer-readable medium of claim 30, wherein the item processing center corresponding to the old address information comprises a United States Post Office that services an address corresponding to the old address information.

32. The computer-readable medium of claim 30, wherein determining if the change-of-address data needs correction comprises determining if at least one of the old address information and the new address information correspond to an actual delivery point in an item delivery system.
